(19) United States
(12) Patent Application Publication
(10) Pub. No.: US 2012/0198970 A1
(43) Pub. Date: Aug. 9, 2012

(54) Oil Filter Removal Tool With Integral Oil Retaining Reservoir

(76) Inventor: Mark Robidoux, Coatesville, PA (US)

(21) Appl. No.: 13/395,740

(22) PCT Filed: Jul. 21, 2010
(86) PCT No.: PCT/US10/42758

§ 371 Date: Apr. 26, 2012

Related U.S. Application Data
(60) Provisional application No. 61/278,022, filed on Oct. 2, 2009.

(51) Int. Cl. B25B 13/48

(52) U.S. Cl. 81/121.1

(57) ABSTRACT

An oil filter removal tool having a base and axially compressible bellows attached at a liquid-tight joint to the base that telescopes over an oil filter being removed defining a container that collects excess oil during filter removal. Base has a filter engaging recess with a fluid passage enabling oil collected during removal to flow into a reservoir between the filter and base. Another reservoir formed between filter and bellows holds additional oil. Joint is formed by a seating arrangement having a configuration that also strengthens the tool. Bellows can compress to seal against pan ensuring oil in oil pan and filter that spills during filter removal remains within tool. After removal, bellows can return to its uncompressed length providing a container sidewall extending outwardly beyond filter enabling collected oil to be transported and dumped into a container.

### CROSS-REFERENCE

This application claims the benefit under 35 U.S.C. §119(e) of U.S. Provisional Application Ser. No. 61/278,022, filed Oct. 2, 2009, the entirety of which is expressly incorporated by reference herein.

### FIELD

The present invention relates to an oil filter removal tool and more particularly to an oil filter removal tool that includes an integral oil retaining reservoir that captures and retains excess oil from an oil filter being removed using the tool.

### BACKGROUND

The process of changing vehicle engine oil has long been messy, wasteful and potentially environmentally harmful. During an oil change, a threaded oil plug is removed from a threaded drain hole in an oil pan attached to the engine underneath the vehicle to allow engine oil in the pan to drain out the hole. While most of the oil drains out the hole, some oil remains in the vehicle's oil filter and can even remain in the engine near a threaded fitting used to attach the oil filter. As a result, removing the oil filter is often quite messy because oil remaining in the filter frequently spills or drips from the filter. In addition, oil remaining in the engine near the filter often unexpectedly flows or drips out the filter fitting once the filter is removed.

Either instance usually leads to the hobbyist or mechanic changing oil to come into direct contact with their skin, which is undesirable. This is undesirable because of chemicals found in engine oil, such as in the form of additives that reduce friction, prevent foaming, inhibit corrosion, and the like, all of which can be hazardous to health.

More often than not, oil spilled from the filter and that drips out the filter fitting drops onto the ground, which is also undesirable. Resulting puddles and stains can not only require cleanup but can lead to environmental contamination as well as cause a vehicle owner into thinking their vehicle is leaking oil when it is not.

What is needed is a solution that prevents excess oil in an oil filter from spilling or dripping from the filter during removal. What is also needed is a solution that is also capable of preventing excess oil flowing out the filter fitting from dripping or spilling.

### SUMMARY

The present invention is directed to an oil filter removal tool having an integral container for collecting oil spilled from an oil filter being removed from a vehicle using the oil filter removal tool. The tool has an elongate oil liquid-guiding bellows of flexible construction that encompasses the filter during removal and a substantially rigid base that includes an oil filter engaging receptacle or socket in which an end of the filter is received. The oil filter engaging receptacle has filter engaging flats formed in a manner that provides an oil fluid passage to an oil collection reservoir formed between the end of the filter and an end wall of the base. Base is configured for releasable engagement with a wrench, such as a socket wrench, ratchet or the like. The bellows defines another oil collection reservoir formed between a sidewall of the bellows and housing sidewall of the filter.

Bellows is formed by an elongate and tubular sidewall of endless construction enabling it to telescope over an oil filter attached to an oil pan of the vehicle in preparation for using the tool to remove the oil filter. Bellows is formed of a flexible and resilient material with it being configured to be axially displaceable so as to be changeable in length. In one embodiment, bellows sidewall is of pleated construction facilitating compression or axial displacement during attachment of the filter to the base and enabling return to its uncompressed length after the filter has been disengaged from the vehicle. Bellows has an uncompressed length so as to extend outwardly beyond a filter received in the filter engaging socket in the base. Bellows has an axially outer sealing surface that seals against an oil pan of the vehicle when the base of the tool is being brought into engagement with a filter attached to the vehicle.

Base is formed of a substantially rigid material having a sidewall in which the oil filter engaging receptacle is formed and an end wall. The oil filter engaging receptacle is formed by flats arranged along an inner surface of the sidewall that correspond to flats formed in the outer surface of the housing of the oil filter so that respective engagement between flats allows transmission of torque from a wrench, such as a ratchet, engaged with the base through the base to the filter to remove the filter. The flats of the filter engaging receptacle are configured to provide one or more oil passages that allow oil to flow into the reservoir formed between the base and an oil filter received in the oil filter engaging receptacle of the base. Each passage can be provided by a flat configuration that provides enough space between the oil filter and an adjacent one of the flats to allow oil flow therebetween. One flat configuration includes a channel formed in or by the flat that permits oil flow therethrough. Another flat configuration allows oil to flow along a corner defined where adjacent flats meet or intersect.

The base and bellows are configured to be assembled together at a joint that provides a liquid-tight seal therebetween. The joint is formed by a seating arrangement that includes a seat integrally formed in the base that engages with a complementary seat integrally formed in the bellows. The base seat is configured to impart increased strength and improved structural rigidity to the base as well as to provide support to the bellows when attached in a manner that also increases its structural rigidity. The bellows seat is constructed to tightly fit around the base seat and can be sized to provide a friction fit with the base.

The base seat has a longitudinally extending seating surface that mates with a longitudinally extending seating surface of the bellows seat. The base seat includes at least one abutment surface against which a complementary abutment surface of the bellows seat abuts when assembled. In a preferred embodiment, each seat has a pair of abutment surfaces axially offset from one another with one of the abutment surfaces disposed on one side of a corresponding seating surface and the other one of the abutment surfaces disposed on the other side of a corresponding seating surface. This axially offset abutment surface and seating surface configuration produces a joint between the bellows and base that results in positive attachment and produces a liquid-tight seal.

In preparation for filter removal, the tool is telescoped over the filter until the filter is seated in the oil filter engaging recess or socket in the base and the sealing end of the bellows has sealed against the oil pan. Once the sealing end of the bellows has come into contact with the oil pan, additional movement of the base toward the filter to seat the filter in the filter engaging recess or socket causes the bellows to axially compress effectively reducing its length. By the bellows sealing against the oil pan, the tool can be used to remove the oil filter while ensuring that excess oil remaining in the filter that spills out of the filter along with oil remaining in the oil pan is collected by the tool so it remains in its integral container.

During filter removal, oil can flow along the filter and/or along the bellows to and through the oil-fluid passage(s) formed between the flats and the filter into the oil collection reservoir in the tool base. Once the tool base reservoir is filled, additional oil is collected in the reservoir between the bellows and oil filter housing. Once the oil filter is completely disengaged from the vehicle, the compressed bellows returns to its uncompressed length thereby providing a container sidewall that extends axially outwardly beyond the filter, which typically remains seated inside the tool. The tool can be maneuvered in a manner like that of any container enabling it to be carried to another container, such as an oil disposal container or the like, where the oil collected in its reservoirs can be dumped into the oil disposal container. If desired, the tool can be maneuvered using the handle of an attached wrench as its handle. After the collected oil is disposed in such an environmentally safe manner, the filter can be removed from the base of the tool and also discarded in an environmentally safe manner.

Other advantages, benefits and features of the present invention will become apparent to those skilled in the art upon reading the detailed description and viewing the related drawings.

### DRAWING DESCRIPTION

One or more preferred exemplary embodiments of the invention are illustrated in the accompanying drawings in which like reference numerals represent like parts throughout and in which:

FIG. 1 is an exploded perspective view of an oil filter attached to an oil pan of a vehicle, an oil filter removal tool constructed in accordance with the present invention equipped with an integral oil spill preventing container, and a wrench used to hold the oil filter removal tool and to apply torque to remove the oil filter;

FIG. 2 is an exploded perspective view of the oil filter removal tool;

FIG. 3 is a rear perspective view of a preferred embodiment of an oil filter engaging base of the tool;

FIG. 4 is a second rear perspective view of the oil filter engaging base of FIG. 3 showing a wrench engaging insert in the base;

FIG. 5 is a top plan view of the oil filter engaging base of FIG. 3 depicting an oil filter receiving receptacle and oil reservoir formed in the base;

FIG. 6 is a side elevation view illustrating telescoping the oil filter removal tool over the oil filter;

FIG. 7 is a cross sectional side elevation view of an oil conducting bellows of the oil filter removal tool sealed against the oil pan with the oil filter seated in the oil filter receiving receptacle formed in the base;

FIG. 8 is a second cross sectional side elevation view of the oil filter removal tool after disengagement of the oil filter from a fitting on the vehicle illustrating capture of excess oil draining from the pan and oil remaining in the filter spilled from the filter by the oil filter removal tool;

FIG. 9 is a third cross sectional side elevation view of the oil filter removal tool after oil filter disengagement illustrating transport of the oil capture by the tool to a container for disposal in an environmentally safe manner;

FIG. 10 is an enlarged exploded fragmentary cross-sectional view depicting construction of a joint where the bellows attaches to the base; and

FIG. 11 is an enlarged fragmentary cross-sectional of the assembled joint attaching the bellows to the base.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

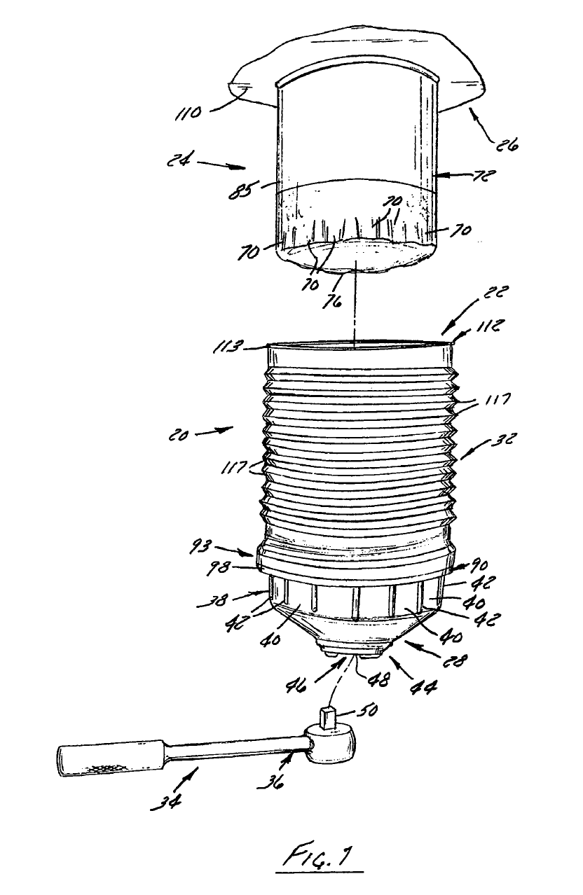

FIGS. 1-9 illustrates a preferred embodiment of an oil filter removal tool 20 constructed in accordance with the present invention formed with an integral container 22 for holding oil that can overflow from a vehicle oil filter 24 being removed using the tool 20 as well as flow of oil remaining in a vehicle 26 from which the filter 24 is being removed. The oil filter removal tool 20 includes a base 28 that has an oil filter engaging receptacle 30 formed in it and a tubular oil-funneling and holding bellows 32 that extends outwardly from the base 28. The oil filter receiving base 28 of the oil filter removal tool 20 is configured to be releasably engaged by another tool 34, such as a socket wrench 36, e.g., ratchet, which can also serve as a handle for the oil filter removal tool 20. Integral oil holding container 22 includes one oil fluid collecting reservoir 78 formed in the base 28 between the base 28 and oil filter 24 received in the receptacle 30 and another oil fluid collecting reservoir 130 formed between the bellows 32 and the oil filter 24.

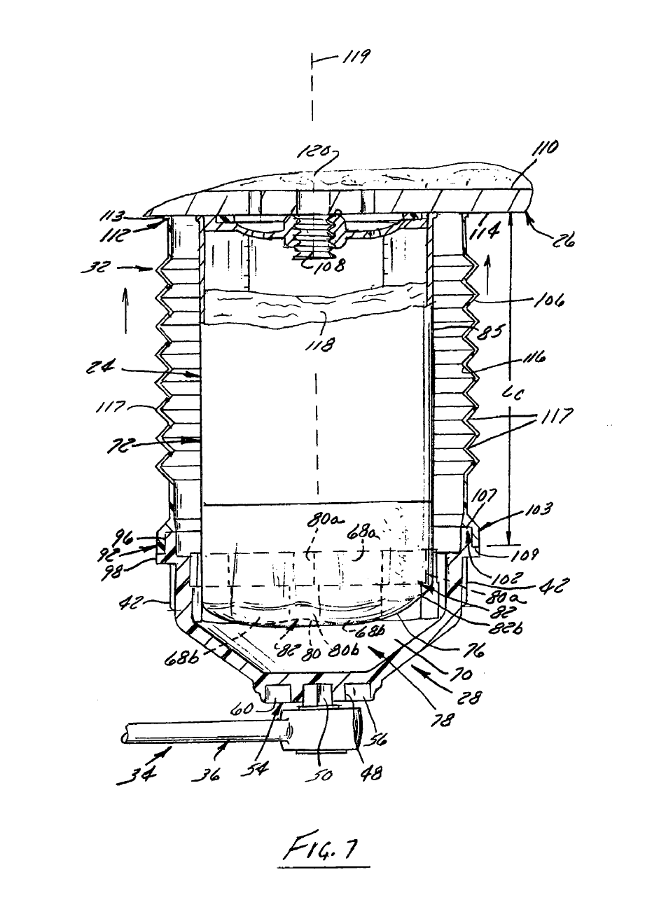

As is shown in FIGS. 1-5, the base 28 is formed of a relatively strong and substantially rigid material capable of withstanding and transmitting torque from wrench 36 to the filter 24 during removal of the filter 24. In one embodiment, the base 28 is molded, such as by injection molding, of a substantially rigid plastic, such as acrylonitrile butadiene styrene (ABS), but can be made of another suitable substantially rigid material, such as a composite, e.g., fiber-reinforced material such as glass-filled nylon, or other material capable of withstanding the torque required for oil filter removal. The base 28 has an outer generally annular sidewall 38 that includes a plurality of hand or finger grip faces 40 with each pair of adjacent faces 40 separated by axially extending grip-facilitating ridges 42 enabling the base 28 to be grasped and manipulated, e.g., turned, by hand. With additional reference to FIGS. 7-9, each hand or finger grip face 40 is disposed radially outwardly of and radially overlies a corresponding filter engaging flat 68 and/or 68′. To help increase structural rigidity of the base 28, each ridge 42 preferably is disposed radially outwardly of and generally axially aligned with a corner or line of intersection between adjacent filter engaging flats 68 and/or 68′ that help form the filter engaging receptacle 30 of the base 28.

The base 28 also includes an end wall 44 that is generally frustum shaped or generally frustoconical having a generally flat tool seat 46 with a socket head receiving receptacle 48 that is configured for receiving a head 50 of the socket wrench 36. Both socket head receiving recess 48 and the head 50 of the socket wrench 36 are of a generally square cross-sectional shape. In one preferred embodiment, the socket head receiving recess 48 has a generally square cross-sectional shape that is about 0.375 inches square (about 9.5 mm) to receive the head 50 of a commercially available ⅜ inch (about 9.5 mm) socket wrench that is typically of hand held construction.

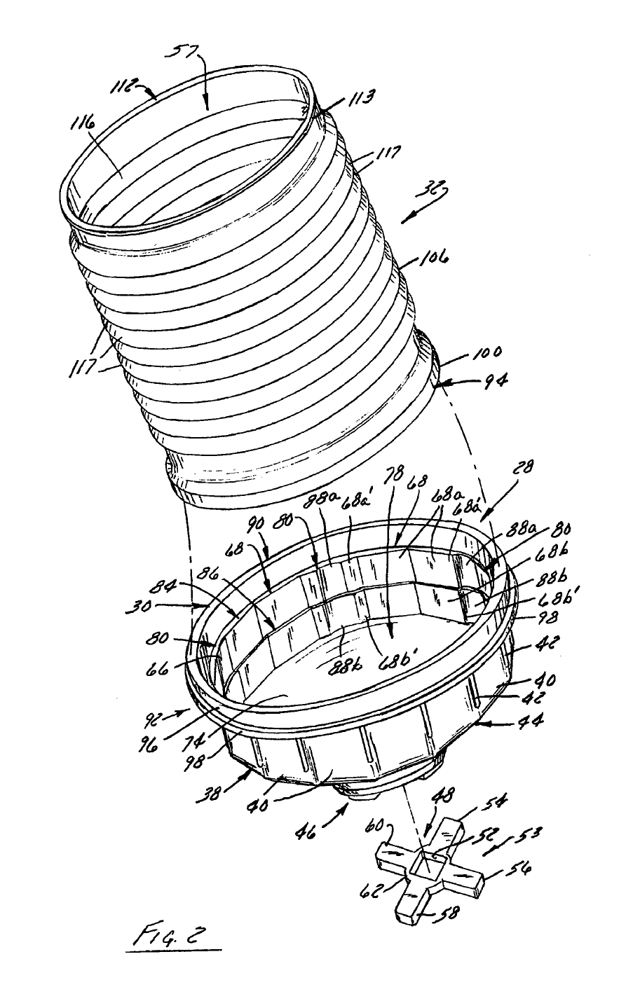

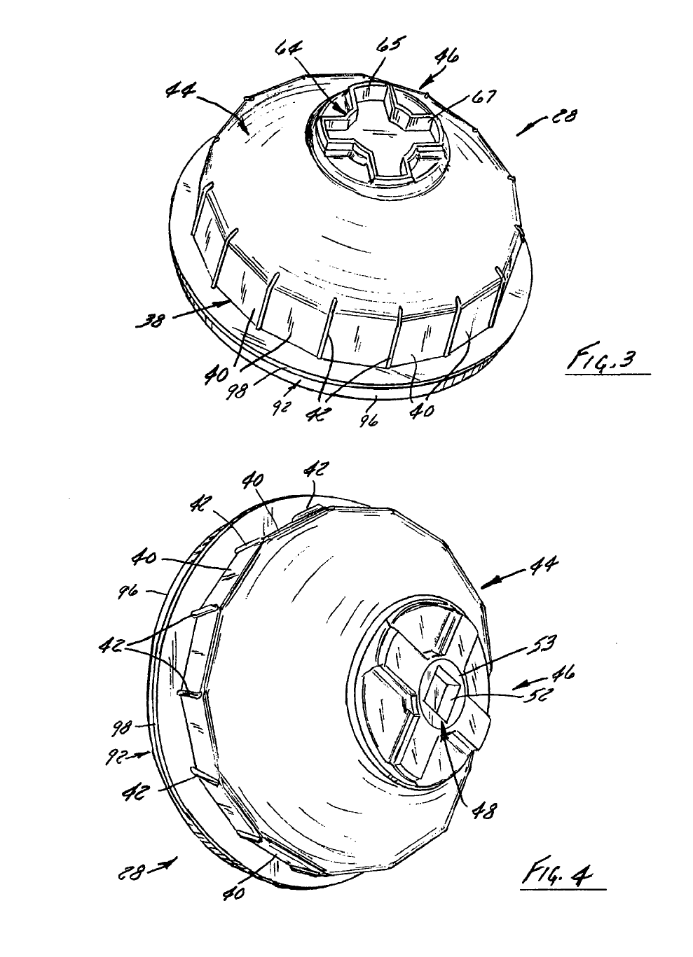

With reference to FIGS. 2-4, socket head receiving recess 48 can be a generally square or rectangular socket receptacle 52 formed in a tool engaging insert 53 fixed to the base 28 in a manner that helps distribute force and torque applied by the wrench 36 during filter removal. Where an insert is used, insert 53 is generally X-shaped having a plurality of pairs of elongate anchor arms 54, 56, 58, and 60 that radiate outwardly from a hub 62 in which socket 52 is disposed. Arms 54, 56, 58 and 60 are fixed to the base 28, such as by being formed in place with the base 28 or in a subsequent operation, distributing applied force and torque along their length. As is shown in FIG. 3, base 28 can be formed with a generally X-shaped recess 64 having a pair of intersecting channels 65, 67 defining a shape generally complementary to the insert 53. Insert 53 can be adhesively attached or otherwise fixed within the insert-receiving recess 64, such as in a separate operation, e.g., molding operation, or the like. Insert 53 can be made of a metallic material, such as a tool steel or the like, and can be hardened, such as in the region of the socket 52, providing increased strength and/or wear resistance.

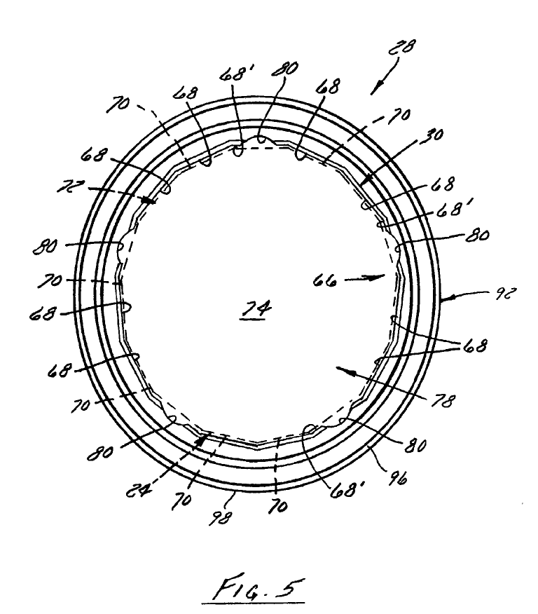

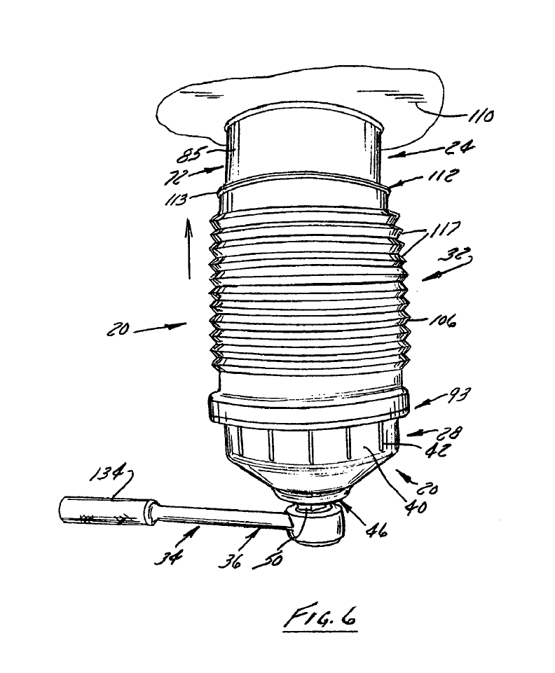

With reference to FIGS. 1, 2, 5 and 6-9, the oil filter engaging receptacle 30 can be defined by an inner sidewall surface 66 of the base sidewall 38 that is three dimensionally contoured for securely gripping oil filter 24. The inner surface 66 is generally annular and has at least a plurality of pairs, i.e., at least three, filter engaging flats 68 arranged about its periphery in a manner where at least a plurality of the flats 68 bear against a corresponding flat 70 formed in an outer housing or can 72 of the oil filter 24 (shown in phantom in FIG. 5) when the filter 24 is received in receptacle 30 enabling torque transfer from wrench 36 to the filter 24.

Adjacent the oil filter gripping surface 66 of the base 28 is an interiorly disposed recessed end wall surface 74 that is spaced axially outwardly from an end wall 76 (FIG. 1) of oil filter 24 received in receptacle 30 a sufficient distance to define an oil collecting reservoir 78 in which excess or spilled oil can flow during changing the filter 24. Inner base end wall surface 74 is spaced from oil filter end wall 76 when filter 24 is received in receptacle 30 a sufficient distance so as to define a reservoir 78 capable of holding at least a plurality of ounces of oil. Although base end wall surface 74 is generally frustum shaped or frustoconical, other shapes and configurations are contemplated.

To enable oil to flow into the tool base reservoir 78 while engaging oil filter 24 during filter removal, one or more of the oil filter engaging flats 68′ have an axially extending channel 80 formed in them that together with a radially outwardly spaced outer sidewall 85 of the oil filter housing or can 72 at or adjacent its flats 70 form an oil flow passage 82 (FIGS. 7-9). In one embodiment, there are a plurality of oil filter engaging flats 68′ configured with such a channel 80 with the flats 68′ spaced apart a sufficient distance to enable oil flow into reservoir 78 from multiple locations. In another embodiment, flats 68′ have a pair of spaced apart longitudinally extending upraised portions defining the channel 80 between them. If desired, channel 80 can be formed at the intersection where adjacent flats 68 meet or intersect. In the preferred embodiment shown in FIGS. 7-9, base 28 is formed to have at least a plurality of pairs, i.e., at least three, channels 80 with the channels 80 extending along the entire periphery of the inner surface 66 of sidewall 38.

As is depicted in FIGS. 2 and 7-9, where the base 28 is configured to engage a plurality of different sized oil filters, oil filter gripping surface 66 can be of diametrically-stepped construction having a plurality of annular radially offset steps 84, 86 that each includes a set of oil filter engaging flats 68a and 68b with each channel 80 having a first channel segment 88a formed in a corresponding flat 68a′ of one step 84 in communication with a second channel segment 88b formed in a corresponding flat 68b′ of the other step 86.

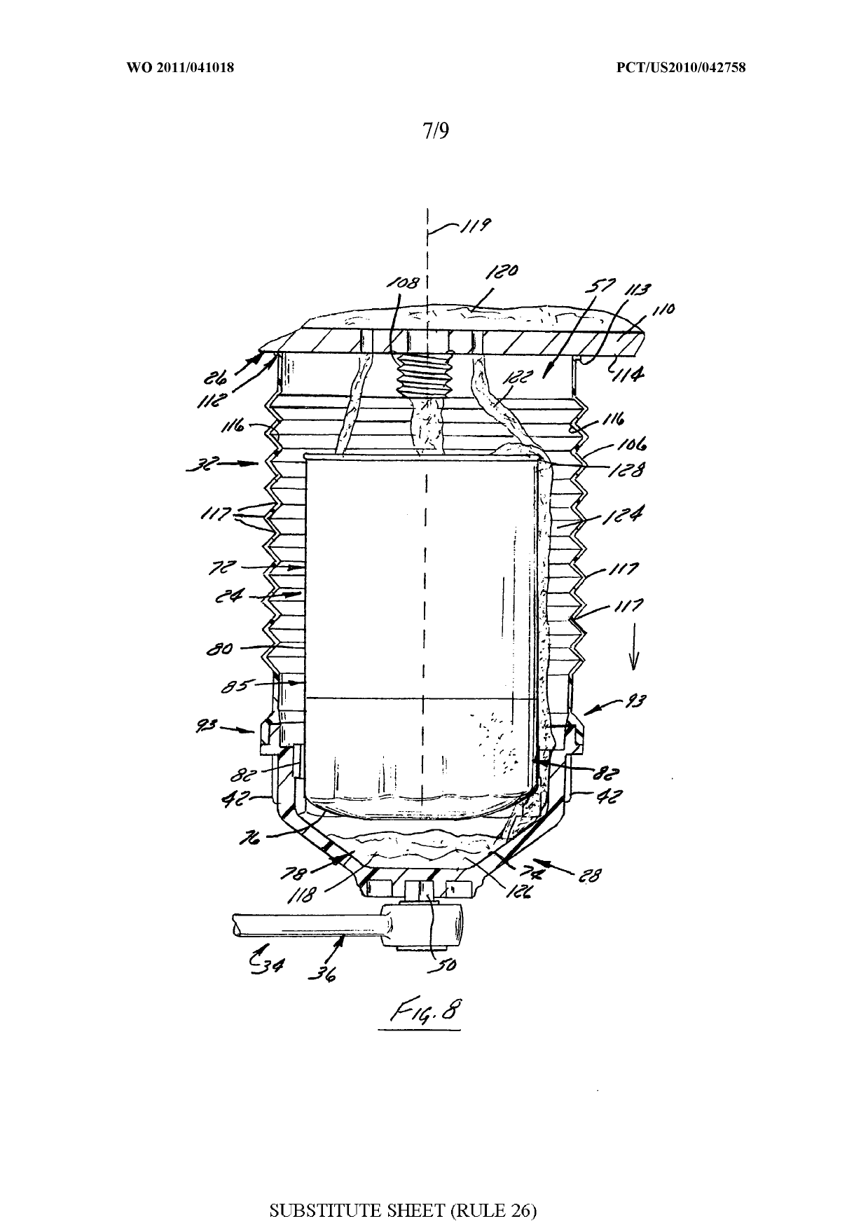

With continued reference to FIGS. 7-9, bellows 32 is formed of an endless annular sidewall 106 forming an oil flow guide 57 of tubular construction that telescopes over oil filter 24 attached to a threaded fitting 108 of the vehicle 26 in the vicinity of its oil pan 110. Bellows 32 is of flexible and axially compressible construction defining an oil filter removal tool 20 having an uncompressed axial length greater than that of oil filter 24, such as is depicted in FIG. 8, when seated in receptacle 30 in base 28. Bellows 32 is made of a flexible, elastomeric and oil impervious material, such as a rubber or another suitable polymeric material. One preferred bellows material is ethylene propylene diene Monomer (EPDM) rubber. Bellows 32 includes a sealing end 112 at its free end that seats against and seals against an outer surface 114 of vehicle 26, such outer surface 114 of oil pan 110, from which oil filter 24 outwardly extends, when telescoped over filter 24 in preparation to remove filter 24. Sealing end 112 is formed by a radially outwardly extending lip 113 that not only helps provide a seal with the outer surface 114 of an oil pan 110 against which the bellows 32 is pressed during filter removal, lip 113 also serves as a flange that help structurally rigidify and support the tubular, e.g., cylindrical, shape of the bellows. Bellows sidewall 106 has an inner surface 116 along which oil can flow during removal and transport of oil filter 24. Bellows sidewall 106 preferably is formed with a plurality of pleats 117 which help enable the bellows 32 to axially compress when pressed up against the oil pan 110 of the vehicle 26 when the tool 20 is being maneuvered into engagement with a filter 24 sought to be removed. In the preferred bellows embodiment shown in the drawing figures, more than half of the bellows sidewall 106 is of pleated construction.

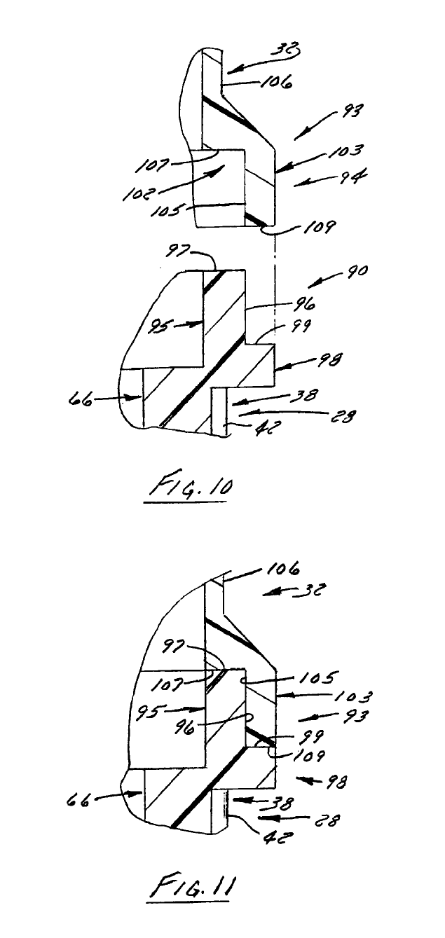

FIGS. 10 and 11 illustrate in more detail a joint 93 formed between the bellows 32 and the base 28 that is configured not only to positively attach the bellows 32 to the base 28 but which also is configured to provide a liquid-tight seal therebetween that prevents any oil received in the tool 20 from leaking out the joint 93. A portion of the sidewall 38 of the base 28 located at or adjacent an outer axial edge or end 90 of the sidewall 38 has an integrally formed seat 92 that is of endless construction and which preferably is generally annular. A portion of the sidewall 106 of the bellows 32 located at or adjacent an axial edge or end 94 of the bellows sidewall 106 has an integrally formed seat 102 that is also of endless construction and which preferably also is generally annular. Seats 92 and 106 are of complementary construction so as to register with one another, such as in the manner depicted in FIGS. 7-11, to produce a joint 93 that is of endless construction and which also preferably is annular.

The bellows-receiving seat 92 is generally L-shaped and formed in an axial end or edge 90 of base sidewall 38. Seat 92 is of endless construction and preferably is annular. Seat 92 includes a generally longitudinally extending rim 95 that provides a generally longitudinally extending seating surface 96 that is of endless construction, preferably generally annular, providing a surface against which a portion of the bellows 32 seats against and seals against when attached to the base 28. Seat 92 also includes a generally outwardly extending flange 98, e.g., lip, having a first abutment surface 97 against which part of an end or edge of the bellows 32 abuts when seated. In the preferred embodiment shown in the drawing figures, flange 98 extends generally radially outwardly, is of endless construction, and preferably also is annular. First abutment surface 97 is depicted in FIGS. 7-11 as being a radial surface that is of endless construction and which also can be annular. Although the first abutment surface 97 is depicted as being generally perpendicular or transverse to a longitudinal direction of the tool 20, abutment surface 97 can be disposed at an angle relative thereto if desired. Radially inboard of the seating surface 96 and the first abutment surface 97 is a second abutment surface 99 against which another part of the end or edge of the bellows 32 abuts when seated. Second abutment surface 99 is depicted in FIGS. 7-11 as being a radial surface that is of endless construction and which also can be annular. Although the second abutment surface 99 is depicted as being generally perpendicular or transverse to the longitudinal direction of the tool 20, abutment surface 99 can also be disposed at an angle relative thereto if desired. First and second abutment surfaces 97 and 99 are longitudinally or axially offset and disposed on opposite sides of seating surface 96 to facilitate quick and easy bellows receipt as well as to facilitate positive attachment of the bellows 32 in a manner that also produces a liquid-tight seal.

The base-receiving seat 102 is also generally L-shaped and formed in an axial end or edge 94 of bellows sidewall 106 that has a cross-sectional thickness greater than the rest of the sidewall 106. Seat 102 is of endless construction and preferably is annular. Seat 102 includes a skirt 103 that is radially outwardly offset from an adjacent part of the sidewall 106 improving structural rigidity of the bellows 32 in the region of the seat 102 and in at least a portion of the sidewall 106 adjacent the seat 102. The inner surface of the skirt 103 includes a generally longitudinally extending seating surface 105 that mates with the seating surface 96 of the base seat 92 when the bellows 32 is seated on the base 28. Seating surface 105 is of endless construction, preferably generally annular, and is configured to be complementary to the seating surface 96 of the base seat 92. Seat 102 also includes first and second abutment surfaces 107 and 109 with one abutment surface 107 being inboard of the other abutment surface 109. Abutment surfaces 107 and 109 are each of endless construction, preferably generally annular, and can be radial as depicted in FIGS. 7-11 or disposed at an angle relative to longitudinal if desired. First and second abutment surfaces 107 and 109 are also longitudinally or axially offset and disposed on opposite sides of seating surface 105 to facilitate quick and easy base receipt as well as to facilitate positive attachment of the base 28 in a manner that also produces a liquid-tight seal.

The base 28 and bellows 32 are constructed so as to provide a tight friction fit between the bellows 32 and base 28 when the bellows 32 is attached to the base 28 with their seats 92 and 102 in mating engagement. Such a tight friction fit helps ensure creation of a joint 93 having positive engagement while facilitating creation of a joint 93 that is liquid-tight. The complementary configuration of seats 92 and 102 facilitate simple and expedient assembly because the end 94 of bellows 32 and the end 90 of the base 28 are brought together with the construction of the seats 92 and 102 enabling skirt 103 to be quickly and easily located and received in the annular pocket defined by rim 95 and flange 98. When the bellows 32 and base 28 are brought together during assembly, complementary seating surfaces 96 and 105 and the first and second abutment surfaces 97, 99 and 107, 109 come into engagement. Seating surfaces 96 and 105 provide radial location during assembly and abutment surfaces 97, 99 and 107, 109 provide longitudinal or axial location during assembly.

Such an arrangement of seating surfaces 96 and 105 and axially offset abutment surfaces 97, 99 and 107, 109 advantageously not only help expedite location and assembly but they also form a joint 93 that positively attaches the bellows 32 to the base 28 in a manner that provides a liquid-tight seal. This arrangement effectively provides three radially spaced apart sealing surfaces with respective radially extending mating inner abutment surfaces 97 and 107 providing a first seal, respective axially extending mating seating surfaces 96 and 105 providing a second seal, and respective radially extending outer abutment surfaces 99 and 109 providing a third seal that is axially offset from the second seal provided by mating abutment surfaces 97 and 107.

In a method of assembly, the bellows 32 is fixed to the base 28, such as either during or as a result of seating of the bellows 32 onto the base 28. In one implementation, the bellows 32 and base 28 are adhesively attached. In another implementation, the bellows 32 is heat sealed to the base 28 either during seating or after they are seated together. If desired, heat sealing can be performed by spin welding, friction welding or ultrasonically welding the bellows 32 to the base 28. In another implementation, the bellows 32 is over-molded onto the base 28.

The construction of the seat 92 of the base 28 helps increase the structural rigidity and strength of the entire base 28 and also helps support and increase the structural rigidity of the bellows 32 when attached to the base 28. Seat 92 is radially outwardly offset from the inner surface 66 of the base sidewall 38 providing space between the bellows sidewall 106 and the housing 72 of an oil filter 24 received in the oil filter engaging receptacle 30 formed in the base 28. Flange 98 extends radially outwardly generally transverse or perpendicular to a central longitudinal axis 119 of the tool 20 with its endless annular construction helping to strengthen and structurally rigidify the base 28 enabling the base 28 to be molded or otherwise formed of a substantially rigid material as described above.

Annular generally axially or longitudinally extending rim 95 is also radially outwardly offset from the inner surface 66 of the base sidewall 38 and also helps strengthen and structurally rigidify the base 28 in a similar manner. In addition, by the rim 95 extending in an axial or longitudinal direction and being disposed inboard of the bellows skirt 103, engagement between the rim 95 and bellows skirt 103 provides support to the bellows 32 helping also to structurally rigidify the bellows 32. By doing so, it enables the bellows 32 to be made of an oil impervious flexible elastomeric material as it helps maintain the tubular shape of the bellows 32 when attached to the base 28.

By providing an oil filter removal tool 20 with a base 28 and bellows 32 having an uncompressed length greater than that of filter 24 seated in base 28, the bellows 32 has a length sufficient to ensure its seal 112 seals against surface 114 when telescoped over an attached filter 24. When telescoped over filter 24 and sealed against pan 110, the oil flow guide 57 formed by an interior surface 116 of bellows sidewall 106 guides any oil 118 left in filter 24 that spills from filter 24 as well as any oil 120 remaining in pan 110 and/or fitting 108 toward reservoir 78 in base 28 when filter 24 is disengaged from fitting 108. As is shown in FIG. 8, leftover oil 120 in the pan 110 can flow 122 in the annular space 124 between bellows sidewall 106 and outer sidewall 85 of the filter can 72 through one or more fluid passages 82 into reservoir 78. Oil 118 remaining in filter 24 that spills from filter 24 can flow 128 down its sidewall 85 and/or along the inner surface 116 of bellows sidewall 106, through passage 82 and into reservoir 78.

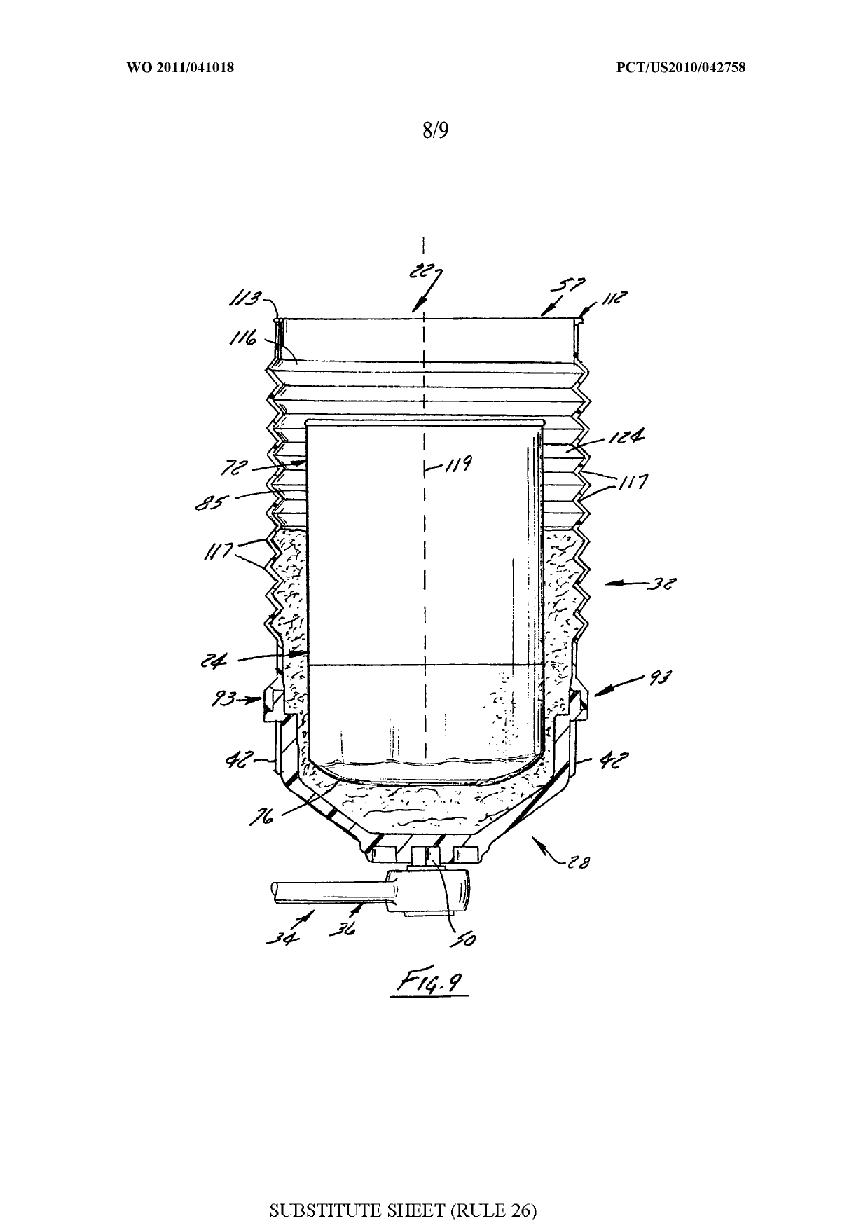

With reference to FIG. 9, after reservoir 78 fills with oil 126, the annular volume 124 between bellows sidewall 106 and filter sidewall 85 provides another oil retaining reservoir 130 that can even include the volume 132 above filter 24 with the base 28 and bellows 32 defining an oil holding volume 22 with sufficient capacity to hold excess oil 118 in the filter 24 that spills from filter 24 during and after removal as well as to hold oil 120 leftover in the oil pan 110 that drains from the pan 110 out fitting 108 when filter 24 is removed. In a preferred embodiment, tool 20 is configured such that reservoir 130 has an oil holding capacity of at least a plurality of pairs of ounces, i.e., at least three ounces.

After the filter 24 has been completely disengaged from fitting 108, wrench handle 134 can be used as a handle for the oil filter removal tool 20 enabling it to be carried using the wrench 34 with the filter 24 still seated in the base 28 in an upright position, such as the generally upright position shown in FIGS. 6-9, preventing it from spilling from bellows 32. The wrench 34 and oil filter removal tool 20 can be rotated to tip bellows 32 downwardly to pour the oil 126 in the oil filter removal tool 20 into a container (not shown) such as a barrel or the like enabling it to be disposed of in an environmentally safe and friendly manner.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. An oil filter removal tool comprising:
(a) a tubular bellows comprised of a flexible material having an oil filter receiving opening at one end;
(b) a substantially rigid oil filter receiving base comprised of a generally annular oil filter engaging receptacle integrally formed therein, the oil filter engaging base fixed to the tubular bellows; and
wherein the tubular bellows and oil filter receiving base encompasses an oil filter received in the oil filter engaging receptacle defining an oil holding volume therebetween.

2. The oil filter removal tool of claim 1 wherein the oil filter engaging receptacle comprises a plurality of pairs of generally planar oil filter housing engaging flats arranged side-by-side defining a generally annular inner sidewall of the oil filter receiving base.

3. The oil filter removal tool of claim 2 wherein the oil holding volume comprises one oil retaining reservoir formed between an oil filter received in the oil filter engaging receptacle and the bellows, wherein the oil filter receiving base comprises an end wall having an interior end wall surface spaced from an end of an oil filter received in the oil filter engaging receptacle defining another oil retaining reservoir therebetween, and wherein at least one of the flats comprises an oil passage permitting flow of oil from the one oil retaining reservoir into the another oil retaining reservoir.

4. The oil filter removal tool of claim 3 wherein the oil passage comprises a channel integrally formed in one of the flats.

5. The oil filter removal tool of claim 3 wherein the oil passage comprises a channel integrally formed between an adjacent pair of the flats.

6. The oil filter removal tool of claim 3 wherein there is at least a plurality of pairs of oil passages disposed about the entire annular inner sidewall of the oil filter receiving base.

7. The oil filter removal tool of claim 2 wherein each adjacent pair of generally planar oil filter housing engaging fiats defines an axially extending corner therebetween and wherein the oil filter engaging base comprises an outer sidewall having a plurality of axially extending grip-facilitating ridges that each axially overlie a corresponding one of the axially extending corners formed between adjacent planar oil filter housing engaging flats.

8. The oil filter removal tool of claim I wherein the oil filter engaging base comprises an generally frustoconical end wall having a generally flat end with a socket head receiving wrench socket integrally formed therein.

9. The oil filter removal tool of claim 8 wherein the oil filter engaging base is formed of plastic and further comprising a metallic insert having a recess formed therein that comprises the socket head receiving wrench socket.

10. The oil filter removal tool of claim 9 wherein the metallic insert is generally X-shaped having a plurality of pairs of elongate arms extending outwardly from a hub in which the socket bead receiving wrench socket is disposed.

11. The oil filter removal tool of claim 1 wherein the tubular bellows comprises an integrally formed seat, wherein the oil filter receiving base comprises an integrally formed seat, and wherein the seat formed in the tubular bellows mates with the seat formed in the oil filter engaging base defining a liquid-tight joint attaching the tubular bellows to the oil filter engaging base.

12. The oil filter removal tool of claim 11 wherein the seat of the bellows is of endless construction, the seat of the oil filter receiving base is of endless construction, and the liquid-tight joint formed by the mated seats is of endless construction.

13. The oil filter removal tool of claim 12 wherein the seat of the bellows is annular, the seat of the oil filter receiving base is annular, and the liquid-tight joint formed by the mated seats is annular.

14. The oil filter removal tool of claim 13 wherein the annular seat of the bellows is configured to provide a tight friction fit with the annular seat of the oil filter receiving base.

15. The oil filter removal tool of claim 14 further comprising a bond between the annular seat of the bellows and the annular seat of the oil filter receiving base positively attaching the bellows to the oil filter receiving base along the liquid-tight joint.

16. The oil filter removal tool of claim 15 wherein the bond comprises one of a hot melt bond, an adhesive bond and a friction welded bond.

17. The oil filter removal tool of claim 13 wherein the seat formed in the bellows comprises an axially extending seating surface and a pair of abutment surfaces axially offset from one another with one of the abutment surfaces disposed on one side of the seating surface and the other one of the abutment surfaces disposed on the other side of the seating surface, and wherein the seat formed in the base comprises an axially extending seating surface and a pair of abutment surfaces axially offset from one another with one of the abutment surfaces disposed on one side of the seating surface and the other one of the abutment surfaces disposed on the other side of the seating surface.

18. An oil filter removal tool comprising:
(a) a tubular bellows comprised of a flexible material having an oil filter receiving opening at one end and comprising an annular seat integrally formed in its other end;
(b) a substantially rigid oil filter receiving base having an end wall and an annular sidewall comprising an oil filter engaging receptacle integrally formed therein and an annular seat that is of substantially complementary construction with the annular seat formed in the other end of the tubular bellows;
wherein the annular seat formed in the tubular bellows mates with the annular seat formed in the oil filter receiving base defining a liquid-tight joint attaching the tubular bellows to the oil filter receiving base; and
wherein the tubular bellows and oil filter engaging receptacle defines an oil retaining reservoir therebetween.

19. The oil filter removal tool of claim 18 wherein the tubular bellows comprises an integrally formed seat, wherein the oil filter receiving base comprises an integrally formed seat, and wherein the seat formed in the tubular bellows mates with the seat formed in the oil filter engaging base defining a liquid-tight joint attaching the tubular bellows to the oil filter engaging base.

20. The oil filter removal tool of claim 19 wherein the seat of the bellows is of endless construction, the seat of the oil filter receiving base is of endless construction, and the liquid-tight joint formed by the mated seats is of endless construction.

21. The oil filter removal tool of claim 20 wherein the seat of the bellows is annular, the seat of the oil filter receiving base is annular, and the liquid-tight joint formed by the mated seats is annular.

22. The oil filter removal tool of claim 21 wherein the annular seat of the bellows is configured to provide a tight friction fit with the annular seat of the oil filter receiving base.

23. The oil filter removal tool of claim 22 further comprising a bond between the annular seat of the bellows and the annular seat of the oil filter receiving base positively attaching the bellows to the oil filter receiving base along the liquid-tight joint.

24. The oil filter removal tool of claim 23 wherein the bond comprises one of a hot melt bond, an adhesive bond and a friction welded bond.

25. The oil filter removal tool of claim 21 wherein the seat formed in the bellows comprises at least one generally axially extending seating surface and a plurality of axially offset generally radially extending seating surfaces, and wherein the seat formed in the oil filter engaging base sidewall comprises at least one generally axially extending seating surface that mates with the at least one generally axially extending seating surface formed in the bellows and a plurality of axially offset generally radially extending seating surfaces with one of the plurality of generally radially extending seating surfaces mating with one of the plurality of generally radially extending seating surfaces formed in the bellows and another one of the plurality of generally radially extending seating surfaces mating with another one of the plurality of generally radially extending seating surfaces formed in the bellows.

26. An oil filter removal tool comprising:
(a) a tubular bellows comprised of a flexible material having an oil filter receiving opening at one end and comprising an annular scat integrally formed in its other end;
(b) a substantially rigid oil filter receiving base having an end wall and an annular sidewall comprising (i) an annular oil filter engaging receptacle integrally formed therein having filter engaging fiats forming a generally annular inner surface of the sidewall with a plurality of annular flats comprising an oil fluid passage, and (ii) an annular seat that is of substantially complementary construction with the annular seat formed in the other end of the tubular bellows;
wherein the annular seat formed in the tubular bellows mates with the annular seat formed in the oil filter receiving base defining a fluid-tight joint attaching the tubular bellows to the oil filter receiving base; and
wherein the tubular bellows and oil filter engaging receptacle defines an oil retaining reservoir comprised of one reservoir formed between one part of a filter received in the filter engaging receptacle and the base and another reservoir formed between another part of the filter received in the filter engaging receptacle and the bellows with the oil fluid passages enabling oil fluid flow between the one reservoir and the another reservoir.
